(19) United States
(12) Patent Application Publication
(10) Pub. No.: US 2019/0228122 A1
(43) Pub. Date: Jul. 25, 2019

(54) METHOD OF FAST IDENTIFYING THE DISTRIBUTION RULE OF WIND SPEED

(71) Applicant: XIAMEN UNIVERSITY OF TECHNOLOGY, Xiamen (CN)

(72) Inventors: Li LIN, Xiamen (CN); Dandan XIA, Xiamen (CN); Wenliang FAN, Xiamen (CN); Haitao HU, Xiamen (CN); Huaifeng WANG, Xiamen (CN)

(73) Assignee: XIAMEN UNIVERSITY OF TECHNOLOGY, Xiamen (CN)

(21) Appl. No.: 16/336,729

(22) PCT Filed: Dec. 7, 2017
(86) PCT No.: PCT/CN2017/114935

§ 371 Date: Mar. 26, 2019

(30) Foreign Application Priority Data
Jul. 19, 2017 (CN) 201710590948.0

(51) Int. Cl. G06F 17/50; G06F 17/18

(52) U.S. Cl. CPC G06F 17/5009; G06F 2217/10; G06F 17/18

(57) ABSTRACT

Disclosed is a method of fast identifying the distribution rule of wind speed, for identifying an optimal distribution rule of known wind speeds, wherein transforming all types of distribution rules to be selected by Rosenblatt transformation to a uniform type based on the selected distribution type of the probability paper, and drawing the reference curve on the probability paper; selecting a plurality of distribution rules, selecting the known wind speed data as the sample data and comparing the point set of the sample data to the reference curve; judging the optimal distribution rule among the selected distribution rules according to the comparison result. The present invention is appropriate for identifying the distribution of wind speed of different range; the method is not specific to any probability paper that has wide applicability. The method is fast and highly efficient and it can achieve comparison of multiple distributions of the wind speed samples at the same time, the distribution types are not limited, the fitting results are visualized. The present invention can quantitatively analyze the degree of fitting of the multi-distribution samples without tedious calculations, thereby scientifically selecting the superior distribution rule of the wind speed samples.

### TECHNICAL FIELD

The present invention relates to analytical method of wind speed, particularly to method of fast identifying the distribution rule of wind speed.

### RELATED ART

China is one of the most concentrate areas that are suffered by wind damage in the world. Wind damage causes huge casualty and economical losses to China every year. Wind speed is an important basic parameter that needs accurate assessment in any wind-involved engineering. Wind load is one of the most important loads in architectural design. The architectural structure can not only withstand the wind speed of a certain time in the past, but also have to safely and reliably withstand the wind speed for a specified period of time. However, the wind speeds in nature have randomness and they have different rules at different times. Therefore, it is necessary to accurately discriminate the wind speed distribution rules of different regions according to different analysis needs to provide reference data for the selection of wind speed for architectural design. At the same time, accurate estimation of wind speed distribution is of great significance for structural design, economic evaluation of wind farm and assessment of wind energy resource.

The selection of the wind speed distribution in the existing known technology is that assuming that the wind speed data satisfies a certain distribution, such as extreme value distribution, Weibull distribution, etc., and the distribution parameters are fitted. Due to the great difference of regional wind fields, the possible distribution of wind speed cannot be determined. Therefore, how to select the distribution pattern quickly, intuitively and accurately is the primary key issue for wind speed data processing and the basis for all subsequent data analysis.

The traditional probability paper method is judged by the closeness of the distribution point and the distribution reference line; as the method is limited by the limited probability paper type, the optimal distribution cannot be quickly identified in many distribution rules.

For a specific set of wind field data, the traditional method of distribution identification compares the wind speed data according to the distribution function on the corresponding probability papers and compares them with the reference lines of the distribution. But this method has limitations:

1. The types of existing probability papers are limited, thus greatly limiting the possibility of distribution selection.

2. It is difficult to compare the degree of fitting of wind speed distribution on two completely different types of probability papers, and it is impossible to make an intuitive fitting judgment.

3. Some probability paper methods also draw other types of distribution on the specified distribution probability paper. Since the distribution curve is limited by the type of probability paper, distortion will undoubtedly lead to obvious comparison error.

### SUMMARY OF THE INVENTION

The object of the present invention is to overcome the deficiencies of the prior art and provide a simple, efficient and more accurate method for quickly identifying the wind speed distribution rule. The technical proposal of the present invention is that:

Method of fast identifying the distribution rule of wind speed, for identifying an optimal distribution rule of known wind speeds, wherein transforming all types of distribution rules to be selected by Rosenblatt transformation to a uniform type based on the selected distribution type of the probability paper, and drawing the reference curve on the probability paper; selecting a plurality of distribution rules, selecting the known wind speed data as the sample data and comparing the point set of the sample data to the reference curve; judging the optimal distribution rule among the selected distribution rules according to the comparison result. In another preferred embodiment, drawing reference curve comprises the steps:

1.1) drawing the coordinate of probability graph: selecting a plurality of points (xᵢ, Fᵢ) in an assumption cumulative distribution function Fₓ(·), the calculated value according to ψ⁻¹[Fₓ(xᵢ)] based on the Rosenblatt transforming is severed as the abscissa of the point i in the probability graph; the calculated value according to ψ⁻¹[Fₓ(xᵢ)] is severed as the ordinate of the point i in the probability graph;

1.2) drawing the reference curve: connecting every point (ψ_{Y}⁻¹(F_{X}(xᵢ)),ψ_{Y}⁻¹(Fᵢ)) to obtain the reference curve.

In another preferred embodiment, the step of generating the point set of the sample data is that:

Arranging the sample data xᵢ in ascending order, then n order statistics of the random variable X is x(1)<x(2)< . . . <x(i)<x(i+1) . . . <x(n);

Determining the sample conversion data pair (x(i), Pᵢ) according to the empirical cumulative distribution function value of the order statistic of x(i); using the maximum likelihood estimation of the sample data to obtain the distribution parameters of the hypothetical distribution type ψⱼ(·) according to the N hypothetical distribution types ψⱼ(·), (j=1, 2, . . . N) that the sample data may obey;

Converting the sample data to sample conversion point that conforms to the hypothetical distribution, and ψ⁻¹[ψⱼ(xᵢ0] and ψ⁻¹(Pᵢ) are the abscissa and the ordinate of the sample point set after the hypothetical distribution respectively;

By analogy, a sample point set for various hypothetical distribution ψⱼ(·) is obtained.

In another preferred embodiment, the step of comparing the sample point set generated by the sample data with the reference curve and testing the degree of fitting is that:

Comparing the sample point set of various hypothetical distributions generated by the sample data with the reference curve, using the following formula to calculate the relative distance between the sample point set and the reference line:

$${D}_{j} = \frac{1}{n} {\sum }_{i = 1}^{n} ( \vert {Ψ}^{- 1} [ {F}_{X} ( {x}_{i} ) ] - {Ψ}^{- 1} [ {Ψ}_{j} ( x ( i ) ) ] \vert sin ( {45}^{°} ) ) , ( j = 1 , 2 , 3 … N ) ;$$

Therein, ω(x(i)) is the actual empirical cumulative distribution function of the ith^{x(i)} rearranged in ascending order, N is the number of hypothetical distribution rules to be tested, n is the number of the samples;

The relative distance is used as a criterion for evaluating the fitting.

In another preferred embodiment, for different hypothetical distributions, if the sample data obeys to a hypothetical distribution, the one with small relative distance is the approximate distribution rule.

The present invention has advantages as follows:

The method of fast identifying the distribution rule of wind speed is an optimal solution to fast identify the distribution rule of wind speed by testing the wind speed in different distribution rules of the wind speed; the method is simple, highly efficient and accurate.

The solution of the present invention is reasonable and simple that it is appropriate for identifying the distribution of wind speed of different range; the method is not specific to any probability paper that has wide applicability. The method is fast and highly efficient and it can achieve comparison of multiple distributions of the wind speed samples at the same time, the distribution types are not limited, the fitting results are visualized. The present invention can quantitatively analyze the degree of fitting of the multi-distribution samples without tedious calculations, thereby scientifically selecting the superior distribution rule of the wind speed samples.

### BRIEF DESCRIPTION OF THE DRAWINGS

FIG. 1 illustrates a schematic diagram of the original wind data of the present invention.

FIG. 2 illustrates a cumulative probability distribution diagram of the data.

FIG. 3 illustrates a density function diagram of the data.

FIG. 4 illustrates a schematic diagram of the comparison of probability in different hypothetical distribution.

FIG. 5 illustrates a schematic diagram of the comparison (Dᵢ value comparison) of degree of fitting in different hypothetical distribution.

### DETAILED DESCRIPTION OF THE EMBODIMENT

The present invention will be further described in accordance with the drawings and the embodiments.

The present invention is provided with a method for fast identifying the distribution rule of wind speed to solve the problems that the probability paper of the existing known technology is not universal, the equivalent can not be directly compared and the results are inaccurate. The method of fast identifying the distribution rule of wind speed, for identifying an optimal distribution rule of known wind speeds, wherein transforming all types of distribution rules to be selected by Rosenblatt transformation to a uniform type based on the selected distribution type of the probability paper, and drawing the reference curve on the probability paper; selecting a plurality of distribution rules, selecting the known wind speed data as the sample data and comparing the point set of the sample data to the reference curve; judging the optimal distribution rule among the selected distribution rules according to the comparison result.

In the present invention, a reference curve is drawn based on the probability paper used; and for the sample data to be identified, a set of sample points is generated using a hypothetical distribution rule of possible obedience. For example, in one identifying, the sample A is generated by using the distribution ONE, the distribution TWO, and the distribution THREE respectively, and the three sample point sets are theoretically in different trajectories; comparing the trajectories of the three sample point sets with the reference curve, the sample point set with the highest degree of fitting indicates that the distribution rule corresponding to the sample points set with the highest degree of fitting is the optimal distribution rule. In the same way, a better distribution rule can be selected through a certain number of operations.

The present invention mainly comprises the steps:

1) the steps of drawing reference curve:

1.1) drawing the coordinate of probability graph: selecting a plurality of points (xᵢ, Fᵢ) in an assumption cumulative distribution function F_{X} (·), the calculated value according to ψ⁻¹[F_{X})(xᵢ)] based on the Rosenblatt transformation is severed as the abscissa of the point i in the probability graph; the calculated value according to ψ⁻¹[F_{X}(xᵢ)] is severed as the ordinate of the point i in the probability graph;

1.2) drawing the reference curve: connecting every point (ψ_{Y}⁻¹(F_{X}(xᵢ)), ψ_{Y}⁻¹(Fᵢ)) to obtain the reference curve.

2) the steps of generating the point set of the sample data:

Arranging the sample data xᵢ in ascending order, then n order statistics of the random variable X is x(1)<x(2)< . . . <x(i)<x(i+1)<x(n).

Determining the sample conversion data pair (x(i), Pᵢ) according to the empirical cumulative distribution function value of the order statistic of x(i); using the maximum likelihood estimation of the sample data to obtain the distribution parameters of the hypothetical distribution type ψⱼ(·) according to the N hypothetical distribution types ψⱼ(·), (j=1, 2, . . . N) that the sample data may obey;

Converting the sample data to sample conversion point that conforms to the hypothetical distribution, and ψ⁻¹[ψⱼ(xᵢ)] and ψ⁻¹(Pᵢ) are the abscissa and the ordinate of the sample point set after the hypothetical distribution respectively;

By analogy, a sample point set for various hypothetical distribution ψⱼ(·) is obtained.

3) the steps of comparing the sample point set generated by the sample data with the reference curve and testing the degree of fitting:

Comparing the sample point set of various hypothetical distributions generated by the sample data with the reference curve, using the following formula to calculate the relative distance between the sample point set and the reference line:

$${D}_{j} = \frac{1}{n} {\sum }_{i = 1}^{n} ( \vert {Ψ}^{- 1} [ {F}_{X} ( {x}_{i} ) ] - {Ψ}^{- 1} [ {Ψ}_{j} ( x ( i ) ) ] \vert sin ( {45}^{°} ) ) , ( j = 1 , 2 , 3 … N ) ;$$

Therein, ψⱼ(x(i)) is the actual empirical cumulative distribution function of the i-th^{x(i)} rearranged in ascending order, N is the number of hypothetical distribution rules to be tested, n is the number of the samples;

The relative distance is used as a criterion for evaluating the fitting.

4) for different hypothetical distributions, if the sample data obeys to a hypothetical distribution, the one with small relative distance is the approximate distribution rule.

The method described in the present invention will be specifically described below by taking a probability distribution paper of a normal distribution as an example.

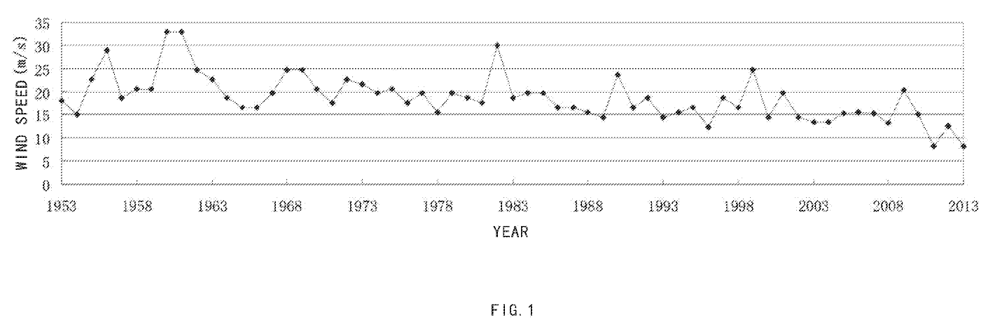

As figured in FIG. 1, a set of average wind speed data is recorded, and the data is input in the table, and a comparison of two or more distribution rules is selected. In the present invention, for the known wind speed data, the reference curve is drawn according to the proposed generalized unified probability map method, different hypothetical distributions are drawn on the same probability paper, and the sample point set generated by the sample data is compared with the reference curve.

According to the closeness of the sample point set and each reference line, the relative optimal distribution is found.

Above mentioned method of fast identifying the distribution rule of wind speed comprises the steps:

1. drawing the probability map coordinates: Assume that the random variables X and Y obey the distribution F(xᵢ) and ψ(yᵢ) respectively, according to the Rosenblatt transformation principle:

When F_{X}(xᵢ)=ψ_{Y}(yᵢ), yᵢ=ψ_{Y}⁻¹(F_{X}(xᵢ));

Therein, xᵢ(i=1, 2, 3, . . . , n) are n samples of the random variable X obeying the distribution function F(xᵢ), the yᵢ(i=1, . . . , n) of n samples of the random variable Y can be obtained.

Whether X obeys F_{X} distribution to converts to whether Y obeys ψ_{Y} distribution. A plurality of points (xᵢ, Fᵢ) are selected in the assumed cumulative distribution function curve F_{X}(·), according to yᵢ=ψ_{Y}⁻¹(F_{X}(xᵢ)), the calculated value by ψ_{Y}⁻¹(F_{X}(xᵢ)) is used as the abscissa of the i-th point in the probability map, the calculated value by ψ_{Y}⁻¹(Fᵢ) is the ordinate in the probability map corresponding thereto.

2. Drawing the reference curve: connect all points (ψ_{Y}⁻¹(F_{X}(xᵢ)), ψ_{Y}⁻¹(Fᵢ)), as F_{X}(xᵢ) equal to ψᵢ, ψ⁻¹[F_{X}(xᵢ)]=ψ⁻¹(Fᵢ), that is to say, the ordinate and abscissa of any point are equal, and the reference curve is the diagonal across the origin.

3. Drawing the set of sample points for the hypothetical distribution that the sample may be obey: Arranging the sample data xᵢ in ascending order, then n order statistics of the random variable X is x(1)<x(2)< . . . <x(i)<x(i+1) . . . <x(n); Determining the sample conversion data pair (x(i), Pᵢ) according to the empirical cumulative distribution function value of the order statistic of x(i); using the maximum likelihood estimation of the sample data to obtain the distribution parameters of the hypothetical distribution type ψⱼ(·) according to the N hypothetical distribution types ψⱼ(·), (j=1, 2, . . . , N) that the sample data may obey; Converting the sample data to sample conversion point that conforms to the hypothetical distribution, and ψ⁻¹[ψⱼ(xᵢ)] and ψ⁻¹(Pᵢ) are the abscissa and the ordinate of the sample point set after the hypothetical distribution respectively; By analogy, a sample point set for various hypothetical distribution ψⱼ(·) (j=1, 2, . . . N) is obtained.

4. testing the fitness: Comparing the set of converted sample points of the plurality of hypothetical distributions generated by the sample data with the distribution reference line, using the following formula to calculate the relative distance between the sample point set and the reference line:

$${D}_{j} = \frac{1}{n} {\sum }_{i = 1}^{n} ( \vert {Ψ}^{- 1} [ {F}_{X} ( {x}_{i} ) ] - {Ψ}^{- 1} [ {Ψ}_{j} ( x ( i ) ) ] \vert sin ( {45}^{°} ) ) , ( j = 1 , 2 , 3 … N ) ;$$

Therein, ψⱼ(x(i)) is the actual empirical cumulative distribution function of the i-th^{x(i)} rearranged in ascending order, N is the number of hypothetical distribution rules to be tested, n is the number of the samples;

The relative distance is used as a criterion for evaluating the fitting.

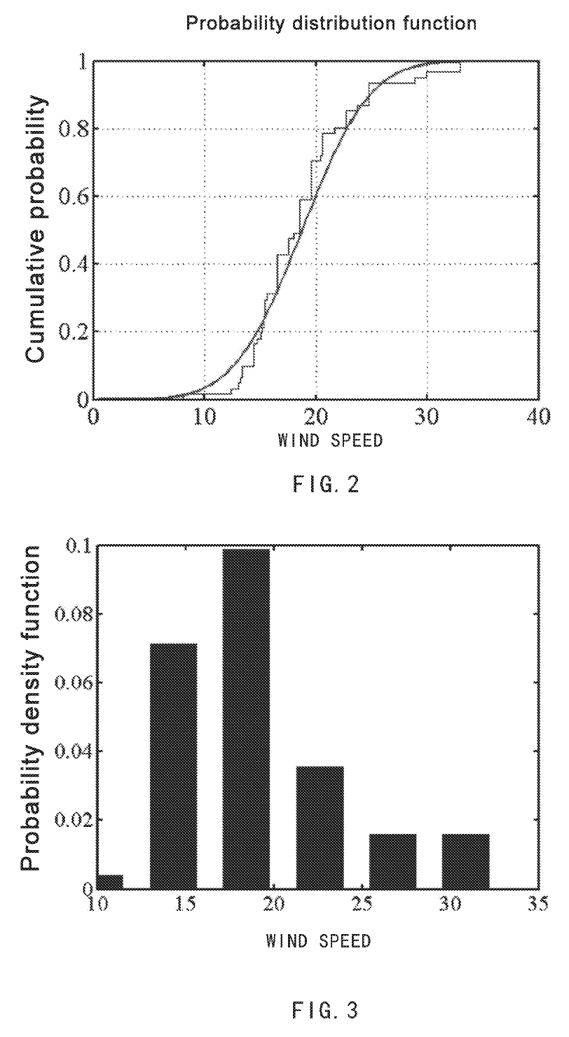

FIG. 2 and FIG. 3 illustrate the cumulative probability distribution map and the probability density function graph based on the original data, a new set of sample points is drawn on the converted probability paper by the above steps 1-4.

Data comparison: For different hypothetical distributions, the calculation results show different Dᵢ values. If the sample obeys the hypothetical distribution, the converted sample point set is closer to the reference distribution line on which it is based. The smaller the Dⱼ value is, the better the degree of fitting is. Based on that, a relatively optimal distribution is found qualitatively.

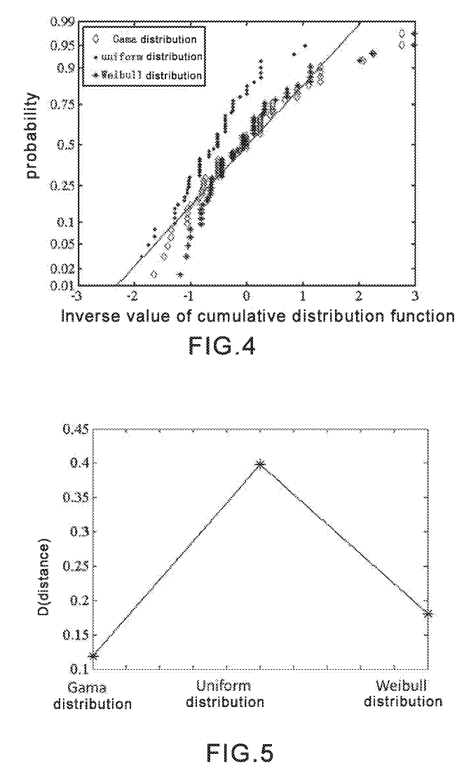

FIG. 4 illustrates the comparison of the probability maps of the three distribution rules (Gama distribution, Norm distribution and Uniform distribution), and the distance between the sample point set and the reference line is calculated according to the probability comparison map.

The optimal distribution is selected by comparing the Dⱼ values with degree of fitting of the selected distribution rules. As shown in FIG. 5, the Dⱼ values are 0.1079, 6.0792 and 0.3095, respectively. The smaller the Dⱼ value is, the higher the degree of fitting is. Therefore, it can be concluded that the Gama distribution is more suitable for this parameter data for the above three distributions.

Similarly, for a specific set of data, by comparing various distribution rules, the optimal parameter distribution can be quantitatively found.

Although the present invention has been described with reference to the preferred embodiments thereof for carrying out the patent for invention, it is apparent to those skilled in the art that a variety of modifications and changes may be made without departing from the scope of the patent for invention which is intended to be defined by the appended claims.

1. Method of fast identifying the distribution rule of wind speed, for identifying an optimal distribution rule of known wind speeds, wherein transforming all types of distribution rules by Rosenblatt transformation to be selected to a uniform type based on the selected distribution type of the probability paper, and drawing the reference curve on the probability paper; selecting a plurality of distribution rules, selecting the known wind speed data as the sample data and comparing the point set of the sample data to the reference curve; judging the optimal distribution rule among the selected distribution rules according to the comparison result.

2. The method of fast identifying the distribution rule of wind speed according to claim 1, wherein drawing reference curve comprises the steps:
1.1) drawing the coordinate of probability graph: selecting a plurality of points (xᵢ, Fᵢ) in an assumption cumulative distribution function F_{X}(·), the calculated value according to ψ⁻¹[F_{X}(xᵢ)] based on the Rosenblatt transformation is severed as the abscissa of the point i in the probability graph; the calculated value according to ψ⁻¹[F_{X}(xᵢ)] is severed as the ordinate of the point i in the probability graph;
1.2) drawing the reference curve: connecting every point (ψ_{Y}⁻¹(F_{X}(xᵢ)), ψ_{Y}⁻¹(Fᵢ)) to obtain the reference curve.

3. The method of fast identifying the distribution rule of wind speed according to claim 2, wherein the step of generating the point set of the sample data is that:
Arranging the sample data X, in ascending order, then n order statistics of the random variable X is x(1)<x(2)< . . . <x(i)<x(i+1) . . . <x(n);
Determining the sample conversion data pair (x(i), Pᵢ) according to the empirical cumulative distribution function value of the order statistic of x(i); using the maximum likelihood estimation of the sample data to obtain the distribution parameters of the hypothetical distribution type ψⱼ(·) according to the N hypothetical distribution types ψⱼ(·), (j=1, 2, . . . , N) that the sample data may obey;
Converting the sample data to sample conversion point that conforms to the hypothetical distribution, and ψ⁻¹[ψⱼ(xᵢ)] and ψ⁻¹(Pᵢ) are the abscissa and the ordinate of the sample point set after the hypothetical distribution respectively;
By analogy, a sample point set for various hypothetical distribution ψⱼ(·) is obtained.

4. The method of fast identifying the distribution rule of wind speed according to claim 3, wherein the step of comparing the sample point set generated by the sample data with the reference curve and testing the degree of fitting is that:
Comparing the sample point set of various hypothetical distributions generated by the sample data with the reference curve, using the following formula to calculate the relative distance between the sample point set and the reference line:
$${D}_{j} = \frac{1}{n} {\sum }_{i = 1}^{n} ( \vert {Ψ}^{- 1} [ {F}_{X} ( {x}_{i} ) ] - {Ψ}^{- 1} [ {Ψ}_{j} ( x ( i ) ) ] \vert sin ( {45}^{°} ) ) , ( j = 1 , 2 , 3 … N ) ;$$
Therein, ψⱼ(x(i)) is the actual empirical cumulative distribution function of the ith^{x(i)} rearranged in ascending order, N is the number of hypothetical distribution rules to be tested, n is the number of the samples;
The relative distance is used as a criterion for evaluating the fitting.

5. The method of fast identifying the distribution rule of wind speed according to claim 4, wherein for different hypothetical distributions, if the sample data obeys to a hypothetical distribution, the one with small relative distance is the approximate distribution rule.
